(19) United States
(12) Patent Application Publication
(10) Pub. No.: US 2021/0286593 A1
(43) Pub. Date: Sep. 16, 2021

(54) RANDOM NUMBER GENERATION APPARATUS, METHOD AND PROGRAM

(71) Applicant: NIPPON TELEGRAPH AND TELEPHONE CORPORATION, Chiyoda-ku (JP)

(72) Inventors: Rina OKADA, Musashino-chi (JP); Satoshi HASEGAWA, Musashino-chi (JP); Shogo MASAKI, Musashino-chi (JP)

(73) Assignee: NIPPON TELEGRAPH AND TELEPHONE CORPORATION, Chiyoda-ku (JP)

(21) Appl. No.: 16/476,728

(22) PCT Filed: Jan. 12, 2018
(86) PCT No.: PCT/JP2018/001472

§ 371 Date: Jul. 9, 2019

(30) Foreign Application Priority Data
Jan. 19, 2017 (JP) 2017-007827

(51) Int. Cl. G06F 7/58; G06F 17/18

(52) U.S. Cl. CPC G06F 7/586; G06F 17/18

(57) ABSTRACT

A random number generation apparatus comprises: a first random number generating part 2 generating a random number u=(u₁, . . . ,u_{D})^{T}∈[−∞,∞]^{D}; a second random number generating part 3 generating a random number v∈[0,f′ₘₐₓ]; and a determining part 4 determining whether f′(x₁=u₁, . . . ,x_{D}=u_{D})≥v or not, and, if f′(x₁=u₁, . . . ,x_{D}=u_{D})≥v, adopting u as a random number according to f′(x₁, . . . ,x_{D}), wherein D is a predetermined positive integer, for i=1, . . . ,D, [hᵢ] is a predetermined possible range for a random variable xᵢ, a hole [h] is [h]=([h₁], . . . ,[h_{D}])^{T}, H is a probability of a predetermined basic distribution function f(x₁, . . . ,x_{D}) in the hole [h], α=1/(1−H), a corrected distribution function f′(x₁, . . . ,x_{D}) is defined by Expressions (1) and (2), and f′ₘₐₓ is a maximum value of f′(x₁, . . . ,x_{D}).

### TECHNICAL FIELD

The present invention relates to a technique for generating random numbers.

### BACKGROUND ART

Patent Literature 1 has been known as a noise addition method that has been conventionally used in anonymization, one of privacy protection techniques (for example, Non-patent literatures 1, 2, 3 4 and 5).

A subject in the above patent literature is to generate random numbers according to an arbitrary probability distribution of an arbitrary dimension.

### PRIOR ART LITERATURE

### Patent Literature

Patent literature 1: Japanese Patent Application Laid-Open No. 2014-081545

### Non-Patent Literature

Non-patent literature 1: Dai Ikarashi, Koji Chida, Katsumi Takahashi, “Efficient Privacy-preserving Cross Tabulation for Multi-valued Attributes”, Papers of Information Processing Society Symposium, Volume 2008, No. 8, 1st Volume, pp. 497-502, Oct. 8, 2008
Non-patent literature 2: Dai Ikarashi, Koji Chida, Katsumi Takahashi, “A Probabilistic Extension of k-Anonimity”, CSS2009, Volume 2009, pp. 1-6, October 2009
Non-patent literature 3: Dai Ikarashi, Koji Chida, Katsumi Takahashi, “Randomized k-Anonymization for Numeric Attributes”, CSS2011, Volume 2011, No. 3, pp. 450-455, Oct. 12, 2011
Non-patent literature 4: Dai Ikarashi, Satoshi Hasegawa, Tatsuya Osame, Ryo Kikuchi, Koji Chida, “A Privacy Preserving Cross-tabulation which Guarantees k-Anonymity by Randomization for Numeric Attributes”, Volume 2012, No. 3, pp. 639-646, Oct. 23, 2012
Non-patent literature 5: Ryo Kikuchi, Dai Igarashi, Koji Chida, Koki Hamada, “Data-Dependent Pk-Anonymization Method for Publishing Useful Anonymized Table”, SCIS2013

### SUMMARY OF THE INVENTION

### Problems to be Solved by the Invention

One of methods for protecting privacy of personal data in a database is anonymization.

In order to anonymize numerical attributes, an anonymization method of causing each attribute value to transition to another attribute value using a random number according to a probability distribution called Laplace distribution (Non-patent literatures 2, 3 and 4) may be used. As an example of numerical attribute personal data, an example of position information (latitude/longitude) about a person will be considered. Though there is almost no possibility that a person exists in an area of the sea other than routes, it may seem as if a person existed in the area due to anonymization.

In order to anonymize a discrete attribute called a category attribute, which is not a numerical attribute, an anonymization method of causing the discrete attribute value to transition to another attribute value with a probability ρ may be used (Non-patent literatures 1 and 5). As an example of the category attribute, purchase information about a person will be considered. Though there cannot be a person who purchases a movie ticket of a high school student price and an alcoholic drink, it may seem as if such a person that belongs to the category area existed due to anonymization.

A reason why such state transition of a numerical attribute and a category attribute occurs is that a random number included in the impossible area is generated.

In order to prevent such impossible state transition, it is necessary to generate random numbers according to a multidimensional probability distribution of an arbitrary dimension such that a probability in an impossible area is zero. A method for generating such random numbers, however, has not been proposed yet.

The present invention is intended to provide a random number generation apparatus, method and program for generating random numbers according to a multidimensional probability distribution such that a probability in a predetermined area is zero.

### Means to Solve the Problems

A random number generation apparatus according to one aspect of the present invention comprises:

a first random number generating part generating a random number u=(u₁, . . . ,u_{D})^{T}∈[−∞,∞]^{D};

a second random number generating part generating a random number v∈[0,f′ₘₐₓ]; and

a determining part determining whether f′(x₁=u₁, . . . ,x_{D}=u_{D})≥v or not, and, if f′(x₁=u₁, . . . ,x_{D}=u_{D})≥v, adopting u as a random number according to f′(x₁, . . . ,x_{D}), wherein

D is a predetermined positive integer, for i=1, . . . ,D, [hᵢ] is a predetermined possible range for a random variable xᵢ, a hole [h] is [h]=([h₁], . . . ,[h_{D}])^{T}, H is a probability of a predetermined basic distribution function f(x₁, . . . ,x_{D}) in the hole [h], α=1/(1−H), a corrected distribution function f′(x₁, . . . ,x_{D}) is defined by Expressions (1) and (2):

[Formula 1]

H=∫ₓ_{₁}_{∈[h}_{₁}_{]}. . . ∫ₓ_{_{D}}_{∈[h}_{_{D}}_{]}f(x₁, . . . ,x_{D})dx₁ . . . dx_{D}

f′(x₁, . . . ,x_{D})=0 if x₁∈[h₁]∧ . . . ∧x_{D}∈[h_{D}] (1)

f′(x₁, . . . ,x_{D})=α·f(x₁, . . . ,x_{D}) otherwise (2)

and f′ₘₐₓ is a maximum value of f′(x₁, . . . ,x_{D}).

A random number generation apparatus according to another aspect of the present invention comprises:

an arithmetic operation part obtaining r=(r₁, . . . ,r_{D})^{T} in the end, by performing, for each of i=1, . . . ,D, a process for generating a random number uᵢç[0,1], obtaining a random number rᵢ=F⁻¹(uᵢ) according to f′(xᵢ) using the generated uᵢ, and xᵢ=rᵢ, wherein

D is a predetermined positive integer, for i=1, . . . ,D, [hᵢ] is a predetermined possible range for a random variable xᵢ, a hole [h] is [h]=([h₁], . . . ,[h_{D}])^{T}, H is a probability of a predetermined basic distribution function f(x₁, . . . ,x_{D}) in the hole [h], α=1/(1−H), a corrected distribution function f′(x₁, . . . ,x_{D}) is defined by Expressions (1) and (2):

[Formula 2]

H=∫ₓ_{₁}_{∈[h}_{₁}_{]}. . . ∫ₓ_{_{D}}_{∈[h}_{_{D}}_{]}f(x₁, . . . ,x_{D})dx₁ . . . dx_{D}

f′(x₁, . . . ,x_{D})=0 if x₁∈[h_{1]}∧ . . . ∧x_{D}∈[h_{D}] (1)

f′(x₁, . . . ,x_{D})=α·f(x₁, . . . ,x_{D}) otherwise (2)

f′(xᵢ) is a peripheral distribution of f′(x₁, . . . ,x_{D}) of xᵢ, F(t₁) is a function defined by Expression (2′):

[Formula 3]

f′(xᵢ)=∫_{-∞}^{∞} . . . ∫_{-∞}^{∞}f′(x₁, . . . ,x_{D})dx₁ . . . dxᵢ₋₁dxᵢ₊₁ . . . dx_{D}

F(tᵢ)=∫_{-∞}^{t}^{ᵢ}f′(xᵢ)dxᵢ (2′)

and F⁻¹(tᵢ) is an inverse function of F(tᵢ).

### Effects of the Invention

It is possible to generate random numbers according to a multidimensional distribution such that a probability in a predetermined area is zero.

### BRIEF DESCRIPTION OF THE DRAWINGS

FIG. 1 is a block diagram for illustrating an example of a random number generation apparatus of a first embodiment;

FIG. 2 is a flowchart for illustrating an example of a random number generation method of the first embodiment;

FIG. 3 is a diagram for illustrating a prior-art technique;

FIG. 4 is a block diagram for illustrating an example of a random number generation apparatus of a second embodiment;

FIG. 5 is a flowchart for illustrating an example of a random number generation method of the second embodiment;

FIG. 6 is a diagram for illustrating a specific example 1; and

FIG. 7 is a diagram for illustrating a specific example 2.

### DETAILED DESCRIPTION OF THE EMBODIMENTS

Embodiments of the present invention will be described below with reference to drawings.

Hereinafter, a distribution function that generates random numbers included in an impossible area is called a basic distribution function f(x₁, . . . ,x_{D}), and a distribution function that does not generate random numbers included in an impossible area is called a corrected distribution function f′(x₁, . . . ,x_{D}), where, ∀D∈N⁺\{0}. In other words, D is a predetermined positive integer.

An impossible area of a random variable is called “a hole”, and the area of the hole is given as a parameter, for example, as shown below.

A hole [h]=([h₁], . . . ,[h_{D}])^{T} is a hypercube in D-dimensional space, and each [hᵢ] indicates a range [sᵢ,eᵢ] for a random variable xᵢ.

The present invention is to generate a random number r∈R^{D} according to an arbitrary D-dimensional probability distribution function f(x₁, . . . ,x_{D}). Intuitively, the process of the present invention is to express the function f(x₁, . . . ,x_{D}) as D one-dimensional probability distribution functions, sequentially generate a random number rᵢ∈R D times, and obtain r=(r₁, . . . ,r_{D})^{T}, a set of rᵢ, in the end.

### First Embodiment

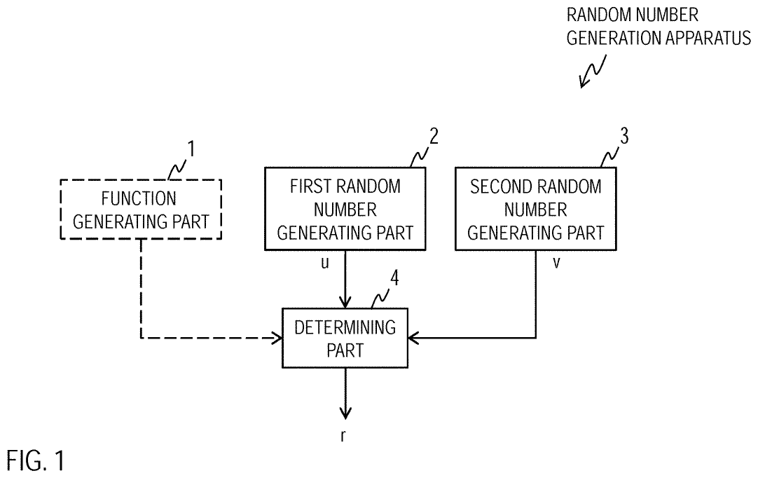

For example, a random number generation apparatus of a first embodiment is provided with a first random number generating part 2, a second random number generating part 3 and a determining part 4 as shown in FIG. 1. The random number generation apparatus may be further provided with a function generating part 1 indicated by a broken line in FIG. 1.

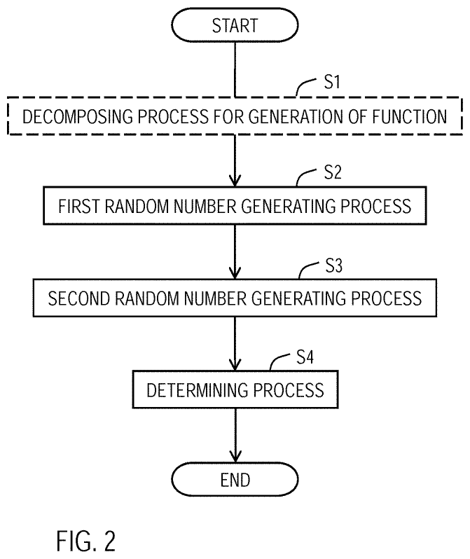

For example, a random number generation method of the first embodiment is realized by each part of the random number generation apparatus performing processes from step S2 to step S4 illustrated in FIG. 2 and described below.

Hereinafter, when the basic distribution function f is given, a procedure for generating a random number r∈R^{D} of the first embodiment will be shown below. In this procedure, a technique of a rejection method is used. Hereinafter, a maximum value of the corrected distribution function f′ is indicated by f′ₘₐₓ.

The random number generation apparatus outputs a D-dimensional random number r=(r₁, . . . ,r_{D})^{T} with the basic distribution function f and the hole [h] as input.

A probability H of a basic distribution function f(x₁, . . . , x_{D}) in the hole [h] is defined as below.

[Formula 4]

H=∫ₓ_{₁}_{∈[h}_{₁}_{]}. . . ∫ₓ_{_{D}}_{∈[h}_{_{D}}_{]}f(x₁, . . . ,x_{D})dx₁ . . . dx_{D}

When α=1/(1−H), a corrected distribution function f(x₁, . . . , x_{D}) is defined by Expressions (1) and (2).

[Formula 5]

f′(x₁, . . . ,x_{D})=0 if x₁∈[h₁]∧ . . . ∧x_{D}∈[h_{D}] (1)

f′(x₁, . . . ,x_{D})=α·f(x₁, . . . ,x_{D}) otherwise (2)

For example, the random number generation apparatus is provided with the function generating part 1 that calculates the probability H and the corrected distribution function f′(x₁ . . . , x_{D}), and the function generating part 1 calculates the probability H and the corrected distribution f′(x₁ . . . , x_{D}) in advance before subsequent processes are performed (step S1). The random number generation apparatus may not be provided with the function generating part 1. In this case, in subsequent processes, as the probability H and the corrected distribution function f′(x₁ . . . , x_{D}), the random number generation apparatus uses those calculated by another apparatus in advance.

The first random number generating part 2 generates a random number u=(u₁, . . . ,u_{D})^{T}∈[−∞,∞]^{D} (step S2). The first random number generating part 2 generates, for example, a uniform random number u=(u₁, . . . ,u_{D})^{T}∈[−∞,∞]^{D} as the random number u. The generated random number u is outputted to the determining part 4.

The second random number generating part 3 generates a random number v∈[0,f′ₘₐₓ] (step S3). The second random number generating part 3 generates a uniform random number v∈[0,f′ₘₐₓ] as the random number v. The generated random number v is outputted to the determining part 4.

The determining part 4 determines whether f′(x₁=u₁, . . . ,x_{D}=u_{D})≥v or not. If f′(x₁=u₁, . . . ,x_{D}=u_{D})≥v, the determining part 4 adopts the u as a random number according to f′(x₁, . . . ,x_{D}) and outputs the random number u (step S4).

If f′(x₁=u₁, . . . ,x_{D}=u_{D})<v, the determining part 4 causes the first random number generating part 2 and the second random number generating part 3 to perform the processes of steps S2 and S3, respectively, again. In other words, the determining part 4 causes the first random number generating part 2 and the second random number generating part 3 to perform the processes of steps S2 and S3, respectively, until f′(x₁=u₁, . . . ,x_{D}=u_{D})≥v.

By the above processes, a multidimensional random number according to a multidimensional probability distribution such that a probability in the hole [h], which is a predetermined area, is zero can be generated. If an expression of a multidimensional probability distribution can be obtained, it is possible to generate random numbers not only from a multidimensional probability distribution such that a probability in an impossible area is zero but from an arbitrary probability distribution.

For example, by using this random number generation method, personal data that is impossible in a real society is not generated when anonymization of a database that includes personal data having a plurality of attributes is performed.

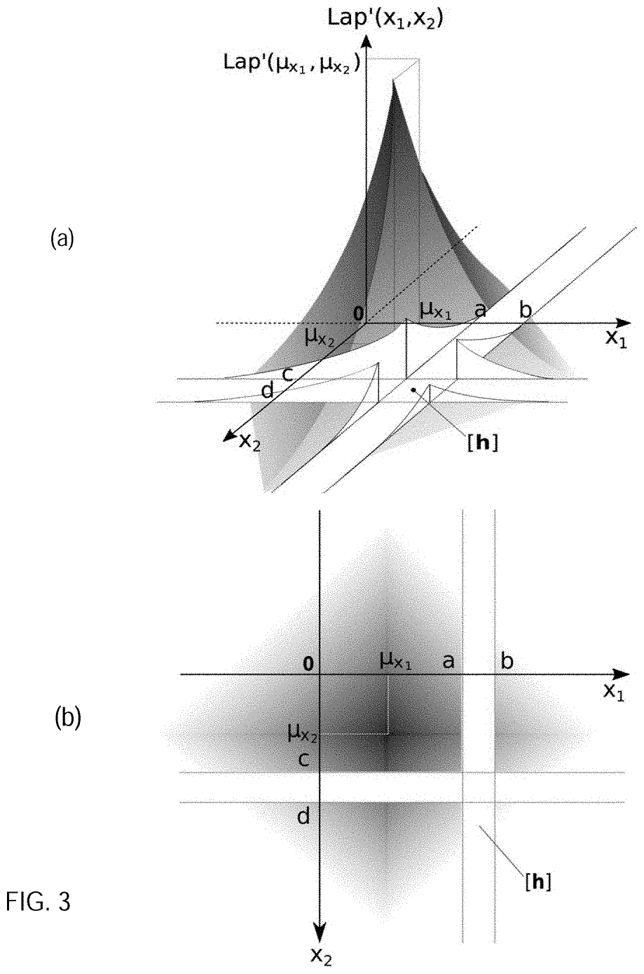

Attributes in a database to be anonymized are not necessarily independent but may be dependent on one another. In Non-patent literature 1, anonymization is applicable only when attributes in a database are independent and cannot be trivially extended to a multidimensional probability distribution such that there are attributes dependent on one another. FIG. 3 shows the above this. FIG. 3(a) is a perspective view, and FIG. 3(b) is a view from above. From FIG. 3, transition to a possible area is also prevented, which is different from what is to be achieved here. One of the points is to assume a simultaneous probability distribution and use a probability distribution having a hole from the simultaneous probability distribution to solve the above. Of course, this random number generation method is applicable to an arbitrary probability distribution and, therefore, can be used for privacy protection other than anonymization.

### Second Embodiment

A procedure for generating a random number r∈R^{D} the processing speed of which is faster than that of the procedure of the first embodiment will be shown below. In this procedure, a technique of an inverse function method is used.

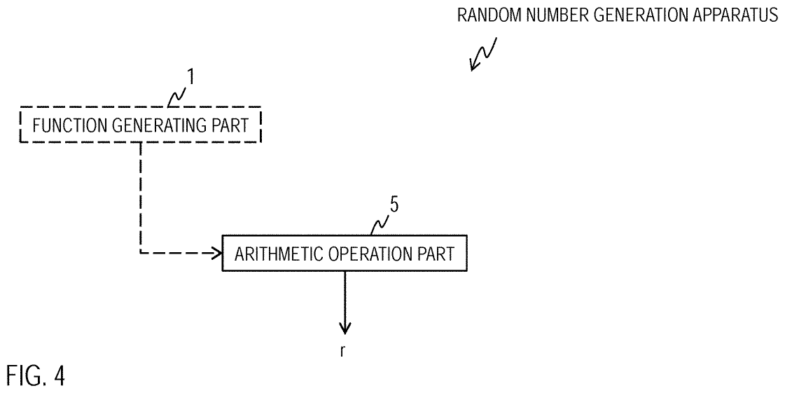

For example, a random number generation apparatus of the second embodiment is provided with an arithmetic operation part 5 as shown in FIG. 4. The random number generation apparatus may be further provided with a function generating part 1 indicated by a broken line in FIG. 4.

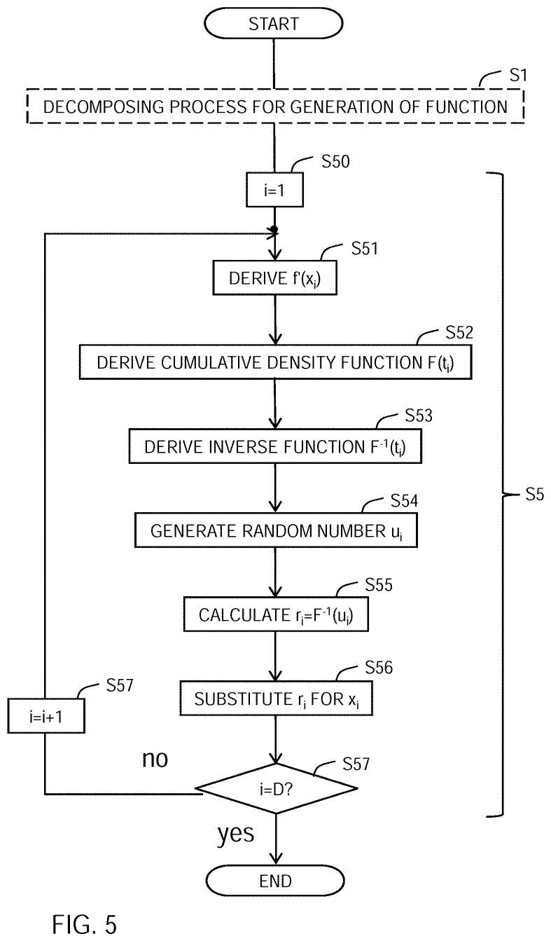

For example, a random number generation method of the second embodiment is realized by each part of the random number generation apparatus performing a process of step S5 illustrated in FIG. 5 and described below.

The random number generation apparatus outputs a D-dimensional random number r=(r₁, . . . ,r_{D})^{T} with the basic distribution function f and the hole [h] as input.

A probability H of a basic distribution function f(x₁, . . . , x_{D}) in the hole [h] is defined as below.

[Formula 6]

H=∫ₓ_{₁}_{∈[h}_{₁}_{]}. . . ∫ₓ_{_{D}}_{∈[h}_{_{D}}_{]}f(x₁, . . . ,x_{D})dx₁ . . . dx_{D}

When α=1/(1−H), a corrected distribution function f′(x₁, . . . , x_{D}) is defined by Expressions (1) and (2).

[Formula 7]

f′(x₁, . . . ,x_{D})=0 if x₁∈[h₁]∧ . . . ∧x_{D}∈[h_{D}] (1)

f′(x₁, . . . ,x_{D})=α·f(x₁, . . . ,x_{D}) otherwise (2)

For example, the random number generation apparatus is provided with the function generating part 1 that calculates the probability H and the corrected distribution function f′(x₁ . . . , x_{D}), and the function generating part 1 calculates the probability H and the corrected distribution f′(x₁ . . . , x_{D}) in advance before subsequent processes are performed (step S1). The random number generation apparatus may not be provided with the function generating part 1. In this case, in subsequent processes, as the probability H and the corrected distribution function f′(x₁ . . . , x_{D}), the random number generation apparatus uses those calculated by another apparatus in advance.

By performing, for each of i=1, . . . , D, a process for generating a random number uᵢ∈[0,1], obtaining a random number rᵢ=F⁻¹(uᵢ) according to f′(xᵢ) using the generated uᵢ, and xᵢ=rᵢ, the arithmetic operation part 5 obtains r=(r₁, . . . ,r_{D})^{T} in the end (step S5), wherein f′(xᵢ) is a peripheral distribution of f′(x₁, . . . ,x_{D}) of xᵢ, F(tᵢ) is a function defined by Expression (2′)

[Formula 8]

f′(xᵢ)=∫_{-∞}^{∞} . . . ∫_{-∞}^{∞}f′(x₁, . . . ,x_{D})dx₁ . . . dxᵢ₋₁dxᵢ₊₁ . . . dx_{D}

F(tᵢ)=∫_{-∞}^{t}^{ᵢ}f′(xᵢ)dxᵢ (2′)

and F⁻¹(tᵢ) is an inverse function of F(tᵢ).

The arithmetic operation part 5 may perform processes from step S50 to step S57 below to perform step S5.

For example, first, for i=1 (step S50), the arithmetic operation part 5 derives a peripheral distribution f′(x₁) of f′(x₁,x₂, . . . ,x_{D}) of x₁ (step S51).

[Formula 9]

f′(xᵢ)=∫_{-∞}^{∞} . . . ∫_{-∞}^{∞}f′(x₁, . . . ,x_{D})dx₁ . . . dxᵢ₋₁dxᵢ₊₁ . . . dx_{D}

Then, the arithmetic operation part 5 derives a cumulative density function F(t₁) (step S52).

[Formula 10]

F(tᵢ)=∫_{-∞}^{t}^{ᵢ}f′(x₁)dx₁

Then, the arithmetic operation part 5 derives F⁻¹(t₁) which is an inverse function of F(t₁) (step S53).

Then, the arithmetic operation part 5 generates a random number u₁∈[0,1] (step S54). The arithmetic operation part 5 generates, for example, a uniform random number u₁∈[0,1] as the random number u₁.

Then, the arithmetic operation part 5 obtains a random number r₁F⁻¹(u₁) according to f′(x₁) using the generated u₁ (step S55). That is, the arithmetic operation part 5 calculates an output value in the case of inputting the generated u₁ to F⁻¹(t₁) and sets the output value as r₁.

Then, the arithmetic operation part 5 substitutes r₁ for x₁ of f′(x₁, . . . ,x_{D}) to obtain f′(x₂, . . . ,x_{D}|x₁=r₁) (step S56).

Then, for integers ^{∀}i∈[2,D], the arithmetic operation part 5 performs an operation similar to steps S51 to S56 described above for f′(xᵢ, . . . ,x_{D}|x₁=r₁, . . . ,xᵢ₋₁=rᵢ₋₁) to obtain r=(r₁, . . . ,r_{D})^{T} (step S57).

As described above, a multidimensional probability distribution may be converted to one-dimensional peripheral distributions to sequentially generate random numbers using an inverse function method.

It is possible to generate random numbers according to a multidimensional probability distribution such that a probability in the hole [h], which is a predetermined area, is zero by the second embodiment as like as the first embodiment though the procedure for generating random numbers of the second embodiment is different from that of the first embodiment.

### Specific Example 1

An example of the corrected distribution function f′ in the case of D=2 will be described below.

Where, N is a predetermined positive integer, and there are N predetermined possible ranges [hᵢ] for the random variable xᵢ. The N predetermined possible ranges are {[hᵢ]}ᵢ₌₁^{N}{([h₁]ᵢ,[h₂]ᵢ)^{T}}ᵢ₌₁^{N}={([(s₁)ᵢ,(e₁)ᵢ],[(s₂)ᵢ,(e₂)ᵢ])^{T}}ᵢ₌₁^{N}. As described above, the number of holes is to be N.

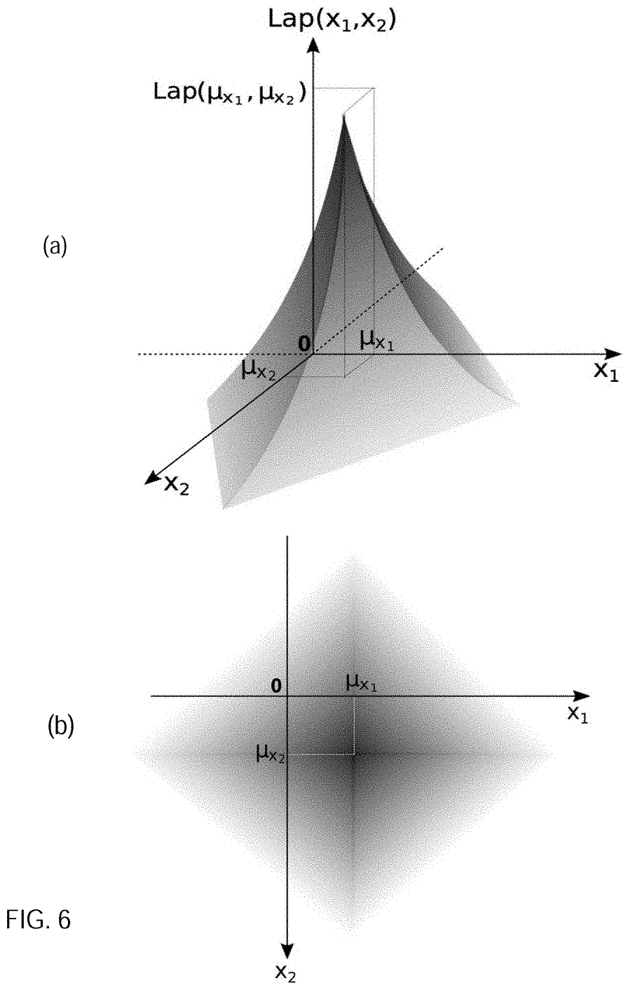

Further, (μₓ₁,2σₓ₁²) and (μₓ₂,2σₓ₂²) are predetermined parameters, and the basic distribution function f′(x1, . . . , x_{D}) is Laplace distribution Lap(x₁,x₂) defined by Expression (3). The Laplace distribution Lap(x₁,x₂) is shown in FIG. 6. FIG. 6(a) is a perspective view, and FIG. 6(b) is a view from above.

$$\begin{matrix}[ Formula 11 ] & \\ Lap ( {x}_{1} , {x}_{2} ) = \frac{1}{2 {σ}_{{x}_{1}}} exp ( - \frac{\vert {x}_{1} - {μ}_{{x}_{1}} \vert}{{σ}_{{x}_{1}}} ) \frac{1}{2 {σ}_{{x}_{2}}} exp ( - \frac{\vert {x}_{2} - {μ}_{{x}_{2}} \vert}{{σ}_{{x}_{2}}} ) & ( 3 )\end{matrix}$$

The sign(a) is a function that outputs a sign {+,−} of an input a, a function g(s,e) is defined by Expressions (5) and (6) when s≤e, and H is defined by Expression (4), then the corrected distribution function f′ is Lap′(x₁,x₂) defined by Expressions (7) and (8).

$$\begin{matrix} [ Formula 12 ] & \\ \begin{matrix} H = {\sum }_{i = 1}^{N} \{ {\int }_{{[ {h}_{2} ]}_{i}} {\int }_{{[ {h}_{1} ]}_{i}} L a p ( {x}_{1} , {x}_{2} ) d {x}_{1} d {x}_{2} \} \\ = \frac{1}{4} {\sum }_{i = 0}^{N} \{ g ( {( {s}_{1} )}_{i} , {( {e}_{1} )}_{i} ) g ( {( {s}_{2} )}_{i} , {( {e}_{2} )}_{i} ) \}\end{matrix} & ( 4 ) \\ [ Formula 13 ] & \\ g ( s , e ) = 2 - exp ( \frac{s - {μ}_{{x}_{1}}}{{σ}_{{x}_{1}}} ) - exp ( \frac{- e + {μ}_{{x}_{1}}}{{σ}_{{x}_{1}}} ) if s \leq {μ}_{{x}_{1}} ⋀ {μ}_{{x}_{1}} \leq e & ( 5 ) \\ g ( s , e ) = sign ( e - {μ}_{{x}_{1}} ) exp ( - \frac{\vert e - {μ}_{{x}_{1}} \vert}{{σ}_{{x}_{1}}} ) - sign ( s - {μ}_{{x}_{1}} ) exp ( - \frac{\vert s - {μ}_{{x}_{1}} \vert}{{σ}_{{x}_{1}}} ) otherwise & ( 6 ) \\ [ Formula 14 ] & \\ {Lap}^{'} ( {x}_{1} , {x}_{2} ) = 0 if {x}_{1} ∈ {[ {h}_{1} ]}_{i} ⋀ ⋯ ⋀ {x}_{D} ∈ {[ {h}_{D} ]}_{i} {\vert}^{{∃}_{i}} & ( 7 ) \\ {Lap}^{'} ( {x}_{1} , {x}_{2} ) = \frac{α}{4 {σ}_{{x}_{1}} {σ}_{{x}_{2}}} exp ( - \frac{\vert {x}_{1} - {μ}_{{x}_{1}} \vert}{{σ}_{{x}_{1}}} ) exp ( - \frac{\vert {x}_{2} - {μ}_{{x}_{2}} \vert}{{σ}_{{x}_{2}}} ) otherwise & ( 8 )\end{matrix}$$

### Specific Example 2

Where, an example of the processes from step S50 to step S56 of the second embodiment will be described.

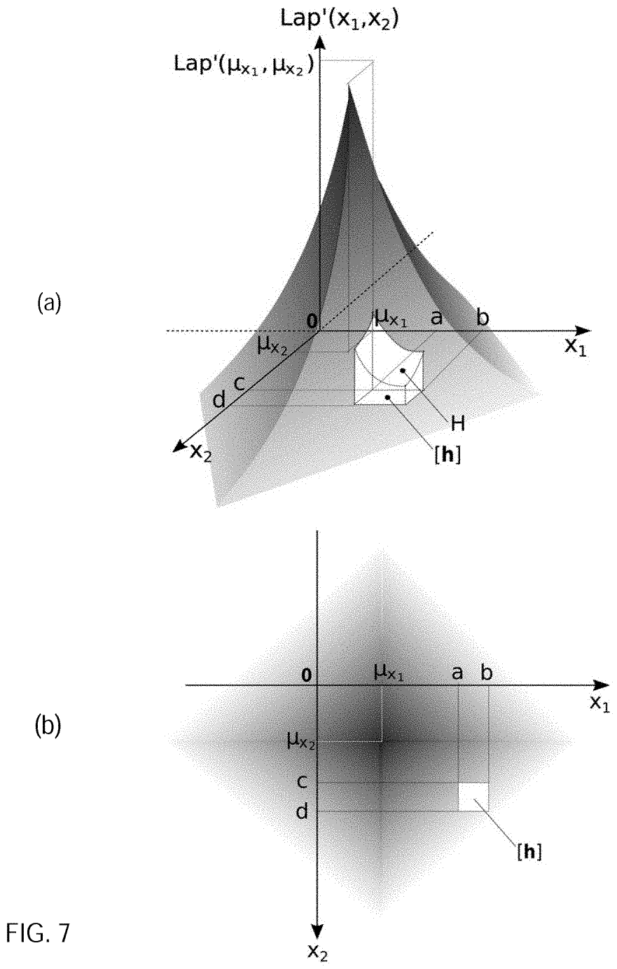

The corrected distribution function f′ is Lap′(x₁,x₂) with one hole [h] that is shown in FIG. 7. FIG. 7(a) is a perspective view, and FIG. 7(b) is a view from above. As shown in FIG. 7, in the specific example 2, the number of [h] is one, and [h]([h₁],[h₂])=([(a),(b)],[(c),(d)]).

Where, a first area S₁ is (x₁≥μₓ₁)∧(x₂≥μₓ₂), a second area S₂ is (x₁≤μₓ₁)∧(x₂≥μₓ₂), a third area S₃ is (x₁≥μₓ₁)∧(x₂≤μₓ₂) and a fourth area S₄ is (x₁≤μₓ₁)∧(x₂≤μₓ₂).

First, a peripheral distribution of x₁ will be considered in order to obtain a random number r₁.

1. If the hole [h] is in the first area S₁ or the second area S₂, the corrected distribution function f′ is Lap′(x₁) defined by Expressions (9) and (10).

$$\begin{matrix} [ Formula 15 ] & \\ {Lap}^{'} ( {x}_{1} ) = \frac{α}{4 {σ}_{{x}_{1}}} exp ( - \frac{\vert {x}_{1} - {μ}_{{x}_{1}} \vert}{{σ}_{{x}_{1}}} ) ( 2 - exp ( \frac{- c + {μ}_{{x}_{2}}}{{σ}_{{x}_{2}}} ) + exp ( \frac{- d + {μ}_{{x}_{2}}}{{σ}_{{x}_{2}}} ) ) if a \leq {x}_{1} \leq b & ( 9 ) \\ {Lap}^{'} ( {x}_{1} ) = \frac{α}{2 {σ}_{{x}_{1}}} exp ( - \frac{\vert {x}_{1} - {μ}_{{x}_{1}} \vert}{{σ}_{{x}_{1}}} ) otherwise & ( 10 )\end{matrix}$$

2. If the hole [h] is in the third area S₃ or the fourth area S₄, the corrected distribution function f′ is Lap′(x₁) defined by Expressions (11) and (12).

$$\begin{matrix} [ Formula 16 ] & \\ La {p}^{'} ( {x}_{1} ) = \frac{α}{4 {σ}_{{x}_{1}}} exp ( - \frac{\vert {x}_{1} - {μ}_{{x}_{1}} \vert}{{σ}_{{x}_{1}}} ) ( 2 + exp ( \frac{c - {μ}_{{x}_{2}}}{{σ}_{{x}_{2}}} ) - exp ( \frac{d - {μ}_{{x}_{2}}}{{σ}_{{x}_{2}}} ) ) if a \leq {x}_{1} \leq b & ( 11 ) \\ {Lap}^{'} ( {x}_{1} ) = \frac{α}{2 {σ}_{{x}_{1}}} exp ( - \frac{\vert {x}_{1} - {μ}_{{x}_{1}} \vert}{{σ}_{{x}_{1}}} ) otherwise & ( 12 )\end{matrix}$$

If a hole is across areas, the above cases 1. and 2. can be combined. Next, in order to generate a random number r₁, inverse functions shown by Expressions (13), (14), (15) and (16) are derived from the cumulative density function:

[Formula 17]

F(tᵢ)=Lap′(x₁≤t₁)=∫_{-∞}^{t}^{ᵢ}Lap′(x₁)dx₁.

Since inverse functions can be derived in other areas by using a similar procedure, description will be made here on only a case where there is a hole in the first area.

Hereinafter,

$$β = 2 - exp ( \frac{- c + {μ}_{{x}_{2}}}{{σ}_{{x}_{2}}} ) + exp ( \frac{- d + {μ}_{{x}_{2}}}{{σ}_{{x}_{2}}} ) \qquad [ Formula 18 ]$$

i) When −∞≤t₁≤μₓ₁:

$$\begin{matrix}[ Formula 19 ] & \\ {t}_{1} = {μ}_{{x}_{1}} + {σ}_{{x}_{1}} log ( \frac{2}{α} F ( {t}_{1} ) ) & ( 13 )\end{matrix}$$

ii) When μₓ₁≤t₁≤a:

$$\begin{matrix}[ Formula 20 ] & \\ {t}_{1} = {μ}_{{x}_{1}} - {σ}_{{x}_{1}} log ( 2 - \frac{2}{α} F ( {t}_{1} ) ) & ( 14 )\end{matrix}$$

iii) When a≤t₁≤b:

$$\begin{matrix} [ Formula 21 ] & \\ {t}_{1} = {μ}_{{x}_{1}} - {σ}_{{x}_{1}} log ( \frac{2}{β} ( 2 - \frac{2}{α} F ( {t}_{1} ) + \frac{β}{2} exp ( \frac{- a + {μ}_{{x}_{1}}}{{σ}_{{x}_{1}}} ) - exp ( \frac{- a + {μ}_{{x}_{1}}}{{σ}_{{x}_{1}}} ) ) ) & ( 15 )\end{matrix}$$

iv) When b≤t₁:

$$\begin{matrix} [ Formula 22 ] & \\ {t}_{1} = {μ}_{{x}_{1}} - {σ}_{{x}_{1}} log [ 2 - \frac{2}{α} F ( {t}_{1} ) - exp ( \frac{- a + {μ}_{{x}_{1}}}{{σ}_{{x}_{1}}} ) + \frac{β}{2} ( exp ( \frac{- a + {μ}_{{x}_{1}}}{{σ}_{{x}_{1}}} ) - exp ( \frac{- b + {μ}_{{x}_{1}}}{{σ}_{{x}_{1}}} ) ) + exp ( \frac{- b + {μ}_{{x}_{1}}}{{σ}_{{x}_{1}}} ) ) & ( 16 )\end{matrix}$$

By substituting u₁∈[0,1] according to a uniform distribution U_{[0,1]} for F(t₁) of Expressions (13), (14), (15) and (16), the random number r₁=t₁ according to Expressions (9) and (10) is generated. A probability density function Lap′(x₂|x₁=r₁) in the case of x₁=r₁ is as follows:

$$\begin{matrix} [ Formula 23 ] & \\ Lap ' ( {x}_{2} \vert {x}_{1} = {r}_{1} ) = 0 if a \leq {r}_{1} \leq b ⋀ c \leq {x}_{2} \leq d & ( 17 ) \\ La {p}^{'} ( {x}_{2} \vert {x}_{1} = {r}_{1} ) = \frac{α}{4 {σ}_{{x}_{1}} {σ}_{{x}_{2}}} exp ( - \frac{\vert {r}_{1} - {μ}_{{x}_{1}} \vert}{{σ}_{{x}_{1}}} ) exp ( - \frac{\vert {x}_{2} - {μ}_{{x}_{2}} \vert}{{σ}_{{x}_{2}}} ) otherwise & ( 18 )\end{matrix}$$

Where, γ is defined by the following expression:

$$γ = exp ( - \frac{\vert {r}_{1} - {μ}_{{x}_{1}} \vert}{{σ}_{{x}_{1}}} ) \qquad [ Formula 24 ]$$

At this time, in order to generate a random number r₂, inverse functions shown in Expressions (19), (20) and (21) are derived from the cumulative density function:

[Formula 25]

F(t₂)=Lap′(x₂≤t₂)=∫_{-∞}^{t}^{₂}Lap′(x₂)dx₂

i) When −∞≤t₂≤μₓ₂:

$$\begin{matrix}[ Formula 26 ] & \\ {t}_{2} = {μ}_{{x}_{2}} + {σ}_{{x}_{2}} log ( \frac{4}{αγ} F ( {t}_{2} ) ) & ( 19 )\end{matrix}$$

ii) When μₓ₂≤t₂≤c:

$$\begin{matrix}[ Formula 27 ] & \\ {t}_{2} = {μ}_{{x}_{2}} - {σ}_{{x}_{2}} log ( 2 - \frac{4}{α γ} F ( {t}_{2} ) ) & ( 20 )\end{matrix}$$

iii) When c≤t₂≤d, F(t₂) is determined regardless of t₂. Therefore, an inverse function does not exist. That is, random numbers within this range are not generated.

iv) When d≤t₂:

$$\begin{matrix}[ Formula 28 ] & \\ {t}_{2} = {μ}_{{x}_{2}} - {σ}_{{x}_{2}} log ( β - \frac{4}{αγ} F ( {t}_{2} ) ) & ( 21 )\end{matrix}$$

By substituting u₂∈[0,1] according to a uniform distribution U_{[0,1]} for F(t₂) of Expressions (19), (20) and (21), the random number r₂=t₂ according to Expressions (17) and (18) is generated. In this way, r=(r₁,r₂)^{T} is generated.

[Program and Recording Medium]

When each process of the random number generation apparatus is realized by a computer, processing content of functions that the random number generation apparatus should have is written by a program. By executing the program by computer, the processes of the random number generation apparatus are realized on the computer.

The program in which the processing content is written can be recorded to a computer-readable recording medium. As the computer-readable recording medium, any recording medium, for example, a magnetic recording device, an optical disk, magneto-optical recording medium or a semiconductor memory is possible.

Each processing part may be configured by causing a predetermined program to be executed on the computer, or at least a part of processing content of the processing part may be realized as hardware.

[Modification]

It goes without saying that the present invention can be appropriately modified within a range not departing from the spirit of the invention.

1. A random number generation apparatus, comprising:
a first random number generating part generating a random number u=(u₁, . . . ,u_{D})^{T}∈[−∞,∞]^{D};
a second random number generating part generating a random number v∈[0,f′ₘₐₓ]; and
a determining part determining whether f′(x₁=u₁, . . . ,x_{D}=u_{D})≥v or not, and, if f′(x₁=u₁, . . . ,x_{D}=u_{D})≥v, adopting u as a random number according to f′(x₁, . . . ,x_{D}), wherein
D is a predetermined positive integer, for i=1, . . . ,D, [hᵢ] is a predetermined possible range for a random variable xᵢ, a hole [h] is [h]=([h₁], . . . ,[h_{D}])^{T}, H is a probability of a predetermined basic distribution function f(x₁, . . . ,x_{D}) in the hole [h], α=1/(1−H), a corrected distribution function f′(x₁, . . . ,x_{D}) is defined by Expressions (1) and (2):
[Formula 29]
H=∫ₓ_{₁}_{∈[h}_{₁}_{]}. . . ∫ₓ_{_{D}}_{∈[h}_{_{D}}_{]}f(x₁, . . . ,x_{D})dx₁ . . . dx_{D}
f′(x₁, . . . ,x_{D})=0 if x₁∈[h₁]∧ . . . ∧x_{D}∈[h_{D}] (1)
f′(x₁, . . . ,x_{D})=α·f(x₁, . . . ,x_{D}) otherwise (2)
and f′_{fax} is a maximum value of f′(x₁, . . . ,x_{D}).

2. A random number generation apparatus comprising:
an arithmetic operation part obtaining r=(r₁, . . . ,r_{D})^{T} in the end, by performing, for each of i=1, . . . ,D, a process for generating a random number uᵢ∈[0,1], obtaining a random number rᵢ=F⁻¹(uᵢ) according to f′(xᵢ) using the generated and xᵢ=rᵢ, wherein
D is a predetermined positive integer, for i=1, . . . ,D, [hᵢ] is a predetermined possible range for a random variable xᵢ, a hole [h] is [h]=([h₁], . . . ,[h_{D}])^{T}, H is a probability of a predetermined basic distribution function f(x₁, . . . ,x_{D}) in the hole [h], α=1/(1−H), a corrected distribution function f′(x₁, . . . ,x_{D}) is defined by Expressions (1) and (2):
[Formula 30]
H=∫ₓ_{₁}_{∈[h}_{₁}_{]}. . . ∫ₓ_{_{D}}_{∈[h}_{_{D}}_{]}f(x₁, . . . ,x_{D})dx₁ . . . dx_{D}
f′(x₁, . . . ,x_{D})=0 if x₁∈[h₁]∧ . . . ∧x_{D}∈[h_{D}] (1)
f′(x₁, . . . ,x_{D})=α·f(x₁, . . . ,x_{D}) otherwise (2)
f′(xᵢ) is a peripheral distribution of f′(x₁, . . . ,x_{D}) of xᵢ, F(tᵢ) is a function defined by Expression (2′):
[Formula 31]
f′(xᵢ)=∫_{-∞}^{∞} . . . ∫_{-∞}^{∞}f′(x₁, . . . ,x_{D})dx₁ . . . dxᵢ₋₁dxᵢ₊₁ . . . dx_{D}
F(tᵢ)=∫_{-∞}^{t}^{ᵢ}f′(xᵢ)dxᵢ (2′)
and F⁻¹(tᵢ) is an inverse function of F(tᵢ).

3. The random number generation apparatus according to claim 1 or 2, wherein
when D=2, N is a predetermined positive integer, there are N predetermined possible ranges [hᵢ] for the random variable xᵢ, the N predetermined possible ranges are {[hᵢ]}ᵢ₌₁^{N}{([h₁]ᵢ,[h₂]ᵢ)^{T}}ᵢ₌₁^{N}={([(s₁)ᵢ,(e₁)ᵢ],[(s₂)ᵢ,(e₂)ᵢ])^{T}}ᵢ₌₁^{N}, (μₓ₁,2σₓ₁²),(μₓ₂,2σₓ₂²) are predetermined parameters, the basic distribution function f(x₁, . . . ,x_{D}) is Lap(x₁,x₂) defined by Expression (3), sign(a) is a function that outputs a sign {+,−} of an input a, a function g(s,e) is defined by Expressions (5) and (6) when s≤e, H described above is defined by Expression (4), and the corrected distribution function f′ is Lap′(x₁,x₂) defined by Expressions (7) and (8):
$$\begin{matrix} [ Formula 32 ] & \\ Lap ( {x}_{1} , {x}_{2} ) = \frac{1}{2 {σ}_{{x}_{1}}} exp ( - \frac{\vert {x}_{1} - {μ}_{{x}_{1}} \vert}{{σ}_{{x}_{1}}} ) \frac{1}{2 {σ}_{{x}_{2}}} exp ( - \frac{\vert {x}_{2} - {μ}_{{x}_{2}} \vert}{{σ}_{{x}_{2}}} ) & ( 3 ) \\ [ Formula 33 ] & \\ \begin{matrix} H = {\sum }_{i = 1}^{N} \{ {\int }_{{[ {h}_{2} ]}_{i}} {\int }_{{[ {h}_{1} ]}_{i}} L a p ( {x}_{1} , {x}_{2} ) d {x}_{1} d {x}_{2} \} \\ = \frac{1}{4} {\sum }_{i = 0}^{N} \{ g ( {( {s}_{1} )}_{i} , {( {e}_{1} )}_{i} ) g ( {( {s}_{2} )}_{i} , {( {e}_{2} )}_{i} ) \}\end{matrix} & ( 4 ) \\ [ Formula 34 ] & \\ g ( s , e ) = 2 - exp ( \frac{s - {μ}_{{x}_{1}}}{{σ}_{{x}_{1}}} ) - exp ( \frac{- e + {μ}_{{x}_{1}}}{{σ}_{{x}_{1}}} ) if s \leq {μ}_{{x}_{1}} ⋀ {μ}_{{x}_{1}} \leq e & ( 5 ) \\ g ( s , e ) = sign ( e - {μ}_{{x}_{1}} ) exp ( - \frac{\vert e - {μ}_{{x}_{1}} \vert}{{σ}_{{x}_{1}}} ) - sign ( s - {μ}_{{x}_{1}} ) exp ( - \frac{\vert s - {μ}_{{x}_{1}} \vert}{{σ}_{{x}_{1}}} ) otherwise & ( 6 ) \\ [ Formula 35 ] & \\ {Lap}^{'} ( {x}_{1} , {x}_{2} ) = 0 if {x}_{1} ∈ {[ {h}_{1} ]}_{i} ⋀ ⋯ ⋀ {x}_{D} ∈ {[ {h}_{D} ]}_{i} {\vert}^{{∃}_{i}} & ( 7 ) \\ {Lap}^{'} ( {x}_{1} , {x}_{2} ) = \frac{α}{4 {σ}_{{x}_{1}} {σ}_{{x}_{2}}} exp ( - \frac{\vert {x}_{1} - {μ}_{{x}_{1}} \vert}{{σ}_{{x}_{1}}} ) exp ( - \frac{\vert {x}_{2} - {μ}_{{x}_{2}} \vert}{{σ}_{{x}_{2}}} ) otherwise . & ( 8 )\end{matrix}$$

4. The random number generation apparatus according to claim 2, wherein
when D=2, the predetermined possible range [hᵢ] for the random variable xᵢ is [hᵢ]=([h₁]ᵢ,[h₂]ᵢ)^{T}=([a,b],[c,d])^{T}, (μₓ₁,2σₓ₁²) and (μₓ₂,2σₓ₂²) are predetermined parameters, a first area S₁ is (x₁≥μₓ₁)∧(x₂≥μₓ₂), a second area S₂ is (x₁≤μₓ₁)∧(x₂≥μₓ₂), a third area S₃ is (x₁≥μₓ₁)∧(x₂≤μₓ₂) and a fourth area S₄ is (x₁≤μₓ₁)∧(x₂≤μₓ₂), if the hole [h] is in the first area S₁ or the second area S₂, the corrected distribution function f′ is Lap′(x₁) defined by Expressions (9) and (10), and if the hole [h] is in the third area S₃ or the fourth area S₄, the corrected distribution function f′ is Lap′(x₁) defined by Expressions (11) and (12):
$$\begin{matrix} [ Formula 36 ] & \\ La {p}^{'} ( {x}_{1} ) = \frac{α}{4 {σ}_{{x}_{1}}} exp ( - \frac{\vert {x}_{1} - {μ}_{{x}_{1}} \vert}{{σ}_{{x}_{1}}} ) ( 2 - exp ( \frac{- c + {μ}_{{x}_{2}}}{{σ}_{{x}_{2}}} ) + exp ( \frac{- d + {μ}_{{x}_{2}}}{{σ}_{{x}_{2}}} ) ) if a \leq {x}_{1} \leq b & ( 9 ) \\ {Lap}^{'} ( {x}_{1} ) = \frac{α}{2 {σ}_{{x}_{1}}} exp ( - \frac{\vert {x}_{1} - {μ}_{{x}_{1}} \vert}{{σ}_{{x}_{1}}} ) otherwise & ( 10 ) \\ La {p}^{'} ( {x}_{1} ) = \frac{α}{4 {σ}_{{x}_{1}}} exp ( - \frac{\vert {x}_{1} - {μ}_{{x}_{1}} \vert}{{σ}_{{x}_{1}}} ) ( 2 + exp ( \frac{c - {μ}_{{x}_{2}}}{{σ}_{{x}_{2}}} ) - exp ( \frac{d - {μ}_{{x}_{2}}}{{σ}_{{x}_{2}}} ) ) if a \leq {x}_{1} \leq b & ( 11 ) \\ {Lap}^{'} ( {x}_{1} ) = \frac{α}{2 {σ}_{{x}_{i}}} exp ( - \frac{\vert {x}_{1} - {μ}_{{x}_{1}} \vert}{{σ}_{{x}_{1}}} ) otherwise . & ( 12 )\end{matrix}$$

5. A random number generation method comprising:
a first random number generating step of a first random number generating part generating a random number u=(u₁, . . . ,u_{D})^{T}∈[−∞,∞]^{D};
a second random number generating step of a second random number generating part generating a random number v∈[0,f′ₘₐₓ]; and
a determining step of a determining part determining whether f′(x₁=u₁, . . . ,x_{D}=u_{D})≥v or not, and, if f′(x₁=u₁, . . . ,x_{D}=u_{D})≥v, adopting u as a random number according to f′(x₁, . . . ,x_{D}), wherein
D is a predetermined positive integer, for i=1, . . . ,D, [hᵢ] is a predetermined possible range for a random variable x a hole [h] is [h]=([h₁], . . . ,[h_{D}])^{T}, H is a probability of a predetermined basic distribution function f(x₁, . . . ,x_{D}) in the hole [h], α=1/(1−H), a corrected distribution function f′(x₁, . . . ,x_{D}) is defined by Expressions (1) and (2):
[Formula 37]
H=∫ₓ_{₁}_{∈[h}_{₁}_{]}. . . ∫ₓ_{_{D}}_{∈[h}_{_{D}}_{]}f(x₁, . . . ,x_{D})dx₁ . . . dx_{D}
f′(x₁, . . . ,x_{D})=0 if x₁∈[h₁]∧ . . . ∧x_{D}∈[h_{D}] (1)
f′(x₁, . . . ,x_{D})=α·f(x₁, . . . ,x_{D}) otherwise (2)
and f′ₘₐₓ is a maximum value of f′(x₁, . . . ,x_{D}).

6. A random number generation method, comprising:
an arithmetic operation step of an arithmetic operation part obtaining r=(r₁, . . . ,r_{D})^{T} in the end, by performing, for each of i=1, . . . ,D, a process for generating a random number uᵢ∈[0,1], obtaining a random number rᵢ=F⁻¹(uᵢ) according to f′(xᵢ) using the generated and xᵢ=rᵢ, wherein
D is a predetermined positive integer, for i=1, . . . ,D, [hᵢ] is a predetermined possible range for a random variable xᵢ, a hole [h] is [h]([h₁], . . . ,[h_{D}])^{T}, H is a probability of a predetermined basic distribution function f(x₁, . . . ,x_{D}) in the hole [h], α=1/(1−H), a corrected distribution function f′(x₁, . . . ,x_{D}) is defined by Expressions (1) and (2):
[Formula 38]
H=∫ₓ_{₁}_{∈[h}_{₁}_{]}. . . ∫ₓ_{_{D}}_{∈[h}_{_{D}}_{]}f(x₁, . . . ,x_{D})dx₁ . . . dx_{D}
f′(x₁, . . . ,x_{D})=0 if x₁∈[h₁]∧ . . . ∧x_{D}∈[h_{D}] (1)
f′(x₁, . . . ,x_{D})=α·f(x₁, . . . ,x_{D}) otherwise (2)
f′(xᵢ) is a peripheral distribution of f′(x₁, . . . ,x_{D}) of xᵢ, F(tᵢ) is a function defined by Expression (2′):
[Formula 39]
f′(xᵢ)=∫_{-∞}^{∞} . . . ∫_{-∞}^{∞}f′(x₁, . . . ,x_{D})dx₁ . . . dxᵢ₋₁dxᵢ₊₁ . . . dx_{D}
F(tᵢ)=∫_{-∞}^{t}^{ᵢ}f′(xᵢ)dxᵢ (2′)
and F⁻¹(tᵢ) is an inverse function of F(tᵢ).

7. A program for causing a computer to function as each part of the random number generation apparatus according to claim 1.
